(19) United States
(12) Patent Application Publication
(10) Pub. No.: US 2014/0199448 A1
(43) Pub. Date: Jul. 17, 2014

(54) DEVICE, SYSTEM AND METHOD FOR FOAMING PRODUCTS

(71) Applicant: SO SODA LTD., Herzliya (IL)

(72) Inventor: Pinchas SHALEV, Herzliya (IL)

(73) Assignee: SO SODA LTD., Herzliya (IL)

(21) Appl. No.: 14/154,894

(22) Filed: Jan. 14, 2014

Related U.S. Application Data
(60) Provisional application No. 61/752,034, filed on Jan. 14, 2013.

(51) Int. Cl. B01F 3/04; A23L 1/32; A23G 9/46; A23L 1/00

(52) U.S. Cl. CPC B01F 3/04446; A23L 1/0097; A23L 1/32; A23G 9/46
USPC 426/300; 261/30; 426/474

(57) ABSTRACT

Device and method for foaming products such as egg-white, ice cream and soft serve ice cream. The device may include a main tank for holding the product, pressure pump to pressurize gas in the main tank and gas tank to provide added gas to the main tank when needed. The product in the main tank is foamed due to the pressure of gas in the main tank and as a result its volume extends by 30% to 60%. A cooling unit may be added to cool the content of the main tank.

### CROSS REFERENCE TO RELATED APPLICATIONS

This application claims the benefit of U.S. Ser. No. 61/752,034, filed on Jan. 14, 2013 (and entitled DEVICE, SYSTEM AND METHOD FOR FOAMING PRODUCTS), which is incorporated in its entirety herein by reference.

### BACKGROUND OF THE INVENTION

Foamed products, such as whipped cream cheese, whipped cream, are formed by infusion of gas, such as air, into the product in the process of its production. Foaming, or the infusion of air, or similar gas, into products, such as soft serve type of ice cream, involves the penetration of gas or air, into the product in substantially even dispersion. Known means, devices and machines that are used for foaming products are usually heavy, gawky and expensive, thus are suitable for large operations, such as restaurants. There is a need for device and method for foaming of products, such as kinds of food, at home, using small-scale and cheap device, that will fit into the anyway crowded kitchen space.

### SUMMARY OF THE INVENTION

A device for foaming product is disclosed comprising a main tank capable of being closed pressure-tight, ingredients capsule chamber and a pressure pump connected to one another in a loop by pipes so that the pressure pump when operative pressurizes the gas in the main tank and pressurized gas from the main tank flows back to the pressure pump via the ingredients capsule chamber. The device also comprising a gas tank connected via a gas valve and gas inlet pipe to provide gas via the ingredients capsule chamber in addition to gas provided from said main tank. Opening and closing of the gas valve is controllable in response to changes in the gas pressure in the main tank. The foaming device may further comprise a cooling unit to cool the content of the main tank. The foamed product may be egg-white, diary cream, soft serve cream and the like.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a pressurizing and foaming device, according to embodiments of the present invention;

FIG. 2 is a schematic illustration of a pressurizing and foaming device, according to embodiments of the present invention;

FIG. 3 is a schematic illustration of a capsule chamber, according to embodiments of the present invention;

FIGS. 4 and 4A are schematic illustrations of a pressurizing and foaming device and of a container to be used with it, according to embodiments of the present invention;

FIGS. 5A, 5B and 5C are schemtatic illustrations of a container comprising magnetically driven strirer, of a coantainer with internal cooling conducting elements, and of 6-pack of containers, according to embodiments of the present invention;

FIGS. 6A, 6B and 6C present schematically various embodiments of devices for the production of pressurized and foamed products, according to embodiments of the present invention; and

FIGS. 7A and 7B depict a device for the production of pressurized and foamed products according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The production of a large variety of products involves infusion of gas, such as air, CO₂ and/or other kinds of gas into the product in order to ‘foam’ it, to affect its appearance, to modify its taste, to change the user experience for a person who uses it, to influence its melting properties (in case of frozen products) and the like. One group of these products involves infusion of gas into edible products, in order to make the product foamier. Examples of such products comprise cream, shake drinks (such as milk shake) and soft ice cream (also known as soft serve). Well known methods for infusing gas/air into products involve manual or mechanical foaming of foamable ingredients such as the white of egg, milk rich with fat, etc. The process of production of some of these products involves also quick freezing of the product to avoid crystallization of the product, in order to obtain a required edible structure. With soft serve, this is accomplished by a special machine at the point of sale. Pre-mixed product is introduced to the storage chamber of the machine where it is kept at 3° C. When product is drawn from the draw valve, fresh mix combined with the targeted quantity of air is introduced to the freezing chamber either by gravity or pump. It is then churned and quick frozen and stored until required.

A device for foaming product such as ice cream may include a main tank wherein said main tank is capable of being closed pressure-tight;an ingredients capsule chamber; and a pressure pump, wherein said pressure pump is connected via an inlet pipe to said ingredients capsule chamber and via outlet pipe to said main tank and said main tank is connected via a third pipe to said ingredients capsule chamber, and wherein when said pressure pump is operating it provides pressured air via said ingredients capsule chamber to said main tank and from said main tank to said ingredients capsule chamber. An embodiment may include a gas tank connected via a gas valve and gas inlet pipe to said third pipe to provide gas via said ingredients capsule chamber in addition to gas provided from said main tank. Opening and closing of said gas valve may be controllable in response to changes in the gas pressure in said main tank. The device may include a cooling unit to cool the content of said main tank. The product may be for example egg-white, diary ice cream and soft serve ice cream. In one embodiment when the pressure pump is operating the volume of said product is extended (overrun) by at least 30%. The overrun may be is no less than 55%. The pressure pump may be adapted to raise the pressure in said main tank to a value between 50 psi to 300 psi. The cooling unit may be adapted to cool the product to a temeperature in the range of −35° C.-10° C.

A method for foaming products may include providing pressurized gas via an ingredients capsule camber to a main tank, the main tank comprising the product; providing pressurized gas from said main tank back to said ingredients capsule chamber; and providing added gas from a gas tank via a gas valve to said ingredients capsule chamber, where the gas valve is controllable in response to changes in the pressure in said main tank. The method may include cooling said product in said main tank. The method may be repeated until the pressure in said main tank reaches a value in the range of 50 psi to 300 psi. The method may be repeated until the volume of said product is extended by at least 30%. In one embodiment the volume of said product is extended at least by 55%.

In modern living the house kitchen is equipped with many devices/machines/appliances that provide, at the reach of the user at home, freshly prepared foods which in older times he/she had to buy made off-home and had to bring it home, and to keep it under preservation conditions until being used, or even the user had to leave his home and go outside to enjoy the food he/she likes, such as freshly grounded and boiled coffee. Today's home appliances provide the option to enjoy such foods and other products at home, freshly made, without having to leave the home for that product. Further, many such products may today be prepared from ingredients that are kept fresh in a closed ingredient's cell, or capsule. This enables one to keep small, pre-measured and vacuum pre-packed amounts of ingredients, typically (but not necessarily) in dry form (in powder and/or solid form) in disposable capsules. For final products comprising large amount of water this arrangement enables large-scale saving in weight (when carrying products prepared off-home) and in storage space (when storing at home before use.

However, foamed products, such as egg-white foam, dairy cream and the like, still need to be prepared off-home (in which case usage of which involves also carrying and storing), or be prepared at home with relatively poor or insufficient results.

There is a need for device, machine and method for foaming products, food and others, at home, so that their overrun (the relative added volume of the product due to the foaming) is kept as high as it is with commercial machines (for example—between 30% and 60% in soft serve creams).

Some kinds of foods are better foamed when chilled and even frozen. Some kinds of foods are better foamed when the foaming process is performed under pressure higher than the ambient pressure level. For example, soft serve cream foamed under pressure may achieve overrun percentage of up to 65% while soft serve prepared under gravity pressure will achieve about 35% overrun. Thus, food foaming device and method for use at home should be adapted to provide pressure during foaming process, typically in the range of 50 psi to 300 psi. Additionally, that device should be adapted to foam—provide and infuse air/gas into the foamed product—evenly across the product. Further, that device and method should be adapted to chill the product to a desired temperature, typically but not limited to, in the range of −35° C.-10° C.

Known researches proved that foaming food products, such as cream, soft serve cream and the like, which are foamed under pressure not only allow for higher overrun but also extend the melting time, improve the texture of the cream and its overall appearance.

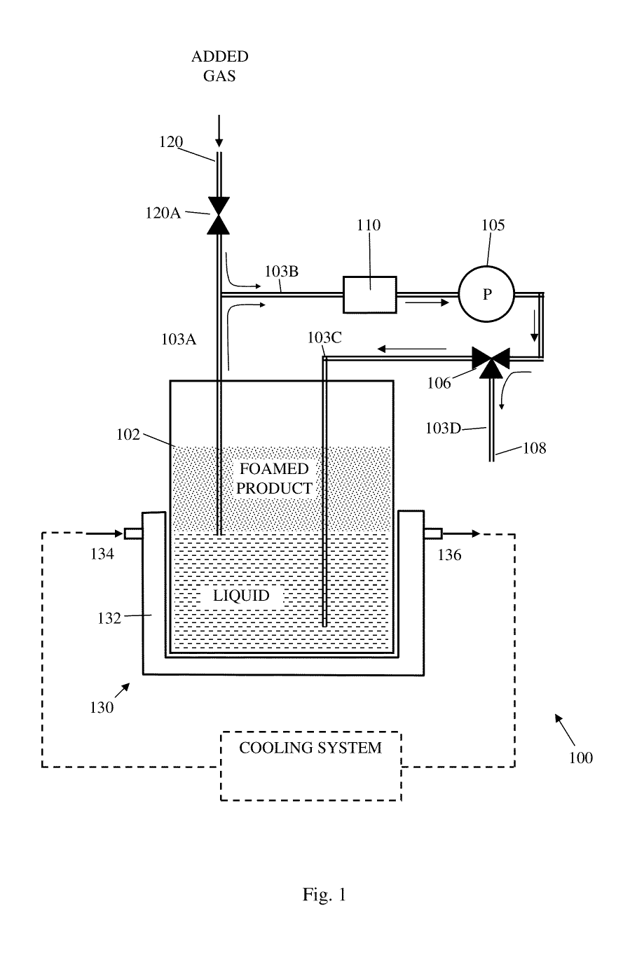

Reference is made now to FIG. 1, which is a schematic illustration of pressurizing and foaming device 100, according to embodiments of the present invention. Device 100 comprises main tank 102, ingredients capsule chamber 110, and pressure pump 105. Main tank 102 may comprise filling opening, enabling to fill, or refill, liquid that will be used for the preparation of the foamed product. Main tank 102 may also comprise opening that will enable thorough cleaning of the inside of the tank. These openings may be made as is known in the art and are not shown in the drawing. Tube 103A crosses through the wall of tank 102 and is made to enable pump 105 to draw gas liquid, gas and foamed product from tank 102 through pipe 103B, capsule chamber 110, pump 105, two-way valve 106 and pipe 103C back into tank 102. Tank 102, its openings and the pipes running through its walls are made to maintain, when tank 102 is closed and ready for operation, the pressure built in it. Added gas inlet 120 is connected via valve 120A to pipe 103B. Product outlet 108 is connected via pipe 103D and two-way valve 106 to the outlet of pump 105.

Main tank 102 may be installed within cooling device 132 so that when the temperature of cooling device 132 drops it may draw heat from main tank 102 and thus cause its temperature to drop as well. Cooling device 132 may be made and work according to well known methods and by the operation of well known devices. According to some embodiments cooling system nay receive cooling fluid through its inlet port 134 and return that fluid, after it absorbed heat from main tank 102, via outlet port 136. Cooling system that provides the cooling fluid may be any known cooling system. According to some embodiments the cooling fluid may be cooling gas and it may be received from another system, such the de-pressurized gas of a refrigerator (not shown).

Valve 120A may be operated to enable flow of added gas into system 100 when it is opened while preventing flow of gas from pipe 103A towards valve 120A. Two-way valve 106 may be operated to control the flow of fluid from pump 105 to either tank 102 via pipe 103C or to product outlet 108 via pipe 103D.

The volume of tank 102 may be set to any desired extent. Typically for single use (i.e.—for the preparation of a foamed product for a single person, the volume of a prepared product may be, after foaming, in the range of 50-300 cc. Pump 105 may be of any required output capacity and any desired maximum pressure. For the production of a personal soft serve of about 250 cc within 2-30 min the pump may have gas pumping capacity of 500 psi (20-1000 cc) and its operational range of pressurizing may be between 50 and 500 psi.

Capsule chamber 110 may be formed to host a capsule in a way that when the capsule has been inserted into it and it was closed, it will be hermetic and will enable gas flowing through it from pipe 103B towards pump 105 to flow through at least one inlet hole and at least one outlet hole made in the capsule's walls so that the flow of gas (and later the flow of fluid or foamed product) will draw the ingredients kept in the capsule into pump 105 and through the piping and tanks of system 100, as will be explained in more details below.

When system 100 is prepared for operation proper amount of fluid may be poured into tank 102 and tank 102 is then hermetically closed. The fluid may be water, milk or similar—depending on the product to be prepared. A capsule of ingredients may be inserted into capsule chamber 110, as is explained in details below and, when chamber 110 is closed the capsule's walls may be pierced. During the first stage of operation pump 105 may be operated and valve 120A may be kept open to enable adding gas (e.g. air, CO₂, and the like) to be added to the total volume of gas in the system, thereby pump 105 builds up pressure in the system. When the pressure reaches a desired level valve 120A may be closed, allowing pump 105 to circulate the content of tank 102 through and through capsule chamber 110 over and over. The portion of pipe 103C that enters into tank 102 is made to end inside the volume occupied by the fluid that was filled in the beginning and its end may be formed to cause extensive circulation inside tank 102. Concurrently, or in advance, as may be required by the recipe of the product, the cooling system may be operated to cool the content of tank 102 to a desired temperature. When system starts the circulation of fluid/gas through the system will draw the ingredients being the content of the capsule and will lead that content into the mixture being formed in tank 102. Due the cooling down of the content of tank 102, the circulation exerted inside tank 102 that mixes the capsule's ingredients into the fluid of the tank and the pressure built in the tank, a foamed product is formed gradually. The temperature of the content of tank 102, the pressure inside the tank. And the amount of gas added to the basic volume of the product—the overrun, may be fully and closely controlled by the controlling of the amount of added gas, the temperature to which tank 102 is chilled and the pressure built in tank 102.

System 100 is presented in FIG. 1 schematically, however it would be apparent to one skilled in the art that the operation of the system may be controlled, partially or fully by a control system (not shown), as is known in the art. Such control system may enable a user of system 100 to choose to prepare a predefined product according to production parameters (pressure, time, temperature, ingredients) saved in the control system. System 100 may also be operated in a manual mode, allowing the user full (or partial only) control over the production parameters.

As the liquid in tank 102 mixes with the ingredients drawn from the capsule, stirred due to the turbulating operation of the end of pipe 103C immersed in the liquid in tank 102 and pressurized as a result of the operation of pump 105, the mixture inside tank 102 starts gaining volume as the gas/air in the system is absorbed in the mixture, and the mixture gradually takes the form of an ice cream, stiffens and the overrun volume builds up.

At the end of production two-way valve 106 may be turned to allow pouring of the product into a bowl, for using by a user. At this stage capsule chamber 110 may be opened and the emptied capsule may be disposed of. According to some embodiments capsule chamber 110 may be made to enable automatic disposal of an emptied capsule when, for example, capsule chamber 110 is opened for reloading.

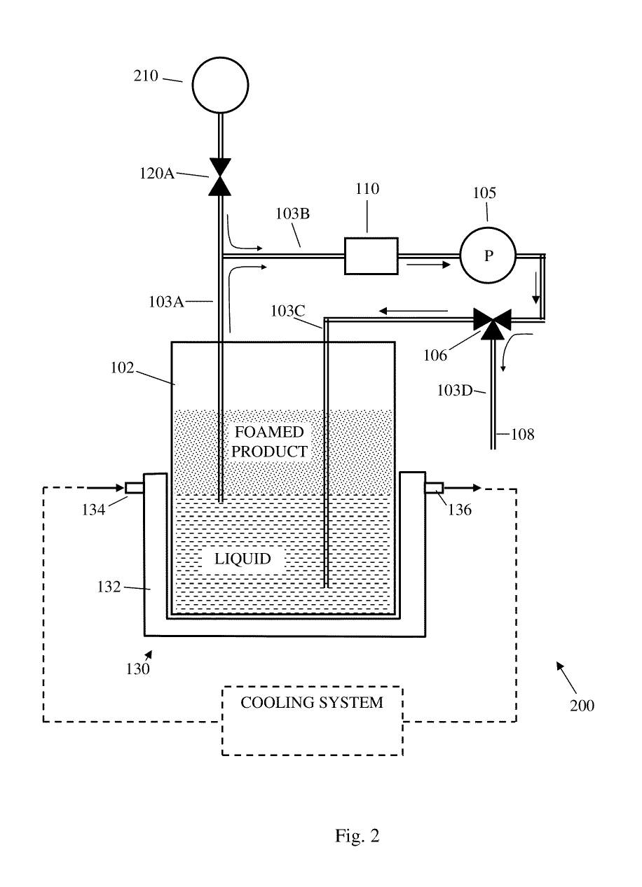

Reference is made now to FIG. 2, which is a schematic illustration of pressurizing and foaming device 200, according to embodiments of the present invention. Device 200 is very much similar to device 100, where similar parts are marked with similar notations. Device 200 may have a gas tank 210 connected via valve 120A to pipe 103B. undesired flow of pressurized gas from tank 210 towards pipe 103A may be prevented by a one-way valve (not shown) that may be installed in pipe 103A. Pressure tank 210 may be made to accumulate pressurized gas and to enable building up the pressure in tank 102. The pressure in tank 210 may be built by an auxiliary pump (or by pump 105, connected via auxiliary set of pipes an valves). The pressurized amount of gas accumulated in tank 210 may be released into tank 102 according to a time-dependent scheme setting the timing of release gas (and as a result als the amount of the released gas). For example, the pressurized gas in tank 210 may be released in pulses the duration of which and the breaks between adjacent pulses define the time scheme. The pressurized gas released from tank 210 may be used to boost up the pressure in tank 102, and to stir and/or infuse air into the processed product in tanl 102.

Control of certain production parameters may set the final product. For example, temperature in the range of 5-10 degrees centigrade may suit production of ice cream; temperature in the range of 0-5 degrees centigrade may suit the production of shake drinks, such as milkshake and temperature in the range of −4 to −1 degrees centigrade may suit the production of soft serve ice cream.

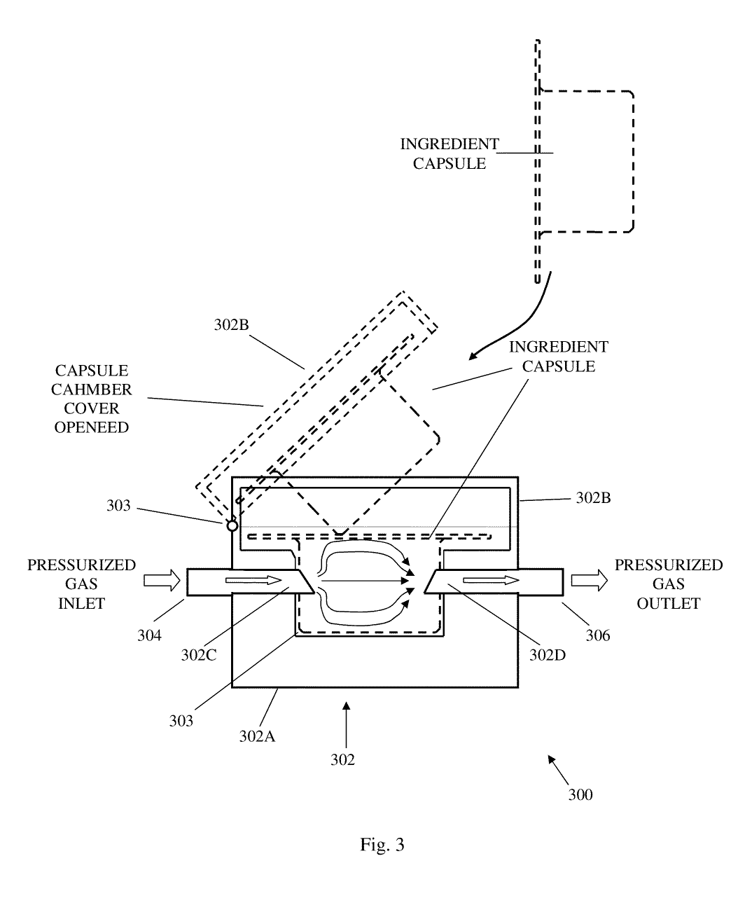

Reference is made now to FIG. 3 which is a schematic illustration of capsule chamber 302, according to embodiments of the present invention. Capsule chamber 302 comprises a main part 302A built to accommodate a capsule in internal room 303 in good suitability. Main part 302A is equipped with inlet port 304 allowing connection of piping of system such as device 100 and device 200. The inner end of inlet port 304 is made with a sharpened end 302C slightly protruding into room 303. Main part 302A is also equipped with outlet port 306 allowing connection of piping of system such as device 100 and device 200. The inner end of outlet port 306 is made with a sharpened end 302D slightly protruding into room 303. capsule chamber 302 also comprise chamber cap 302B, made to open when needed in order to allow insertion of a new capsule and/or disposal of an emptied capsule. Cap 302B may be made to insert a fresh capsule into room 303 so that when it is fully inserted sharpened ends 302C and 302D form holes in the walls of the capsule, thus allowing flowing fluid running through capsule chamber 302 to draw the content of the capsule and run it into the piping of the system.

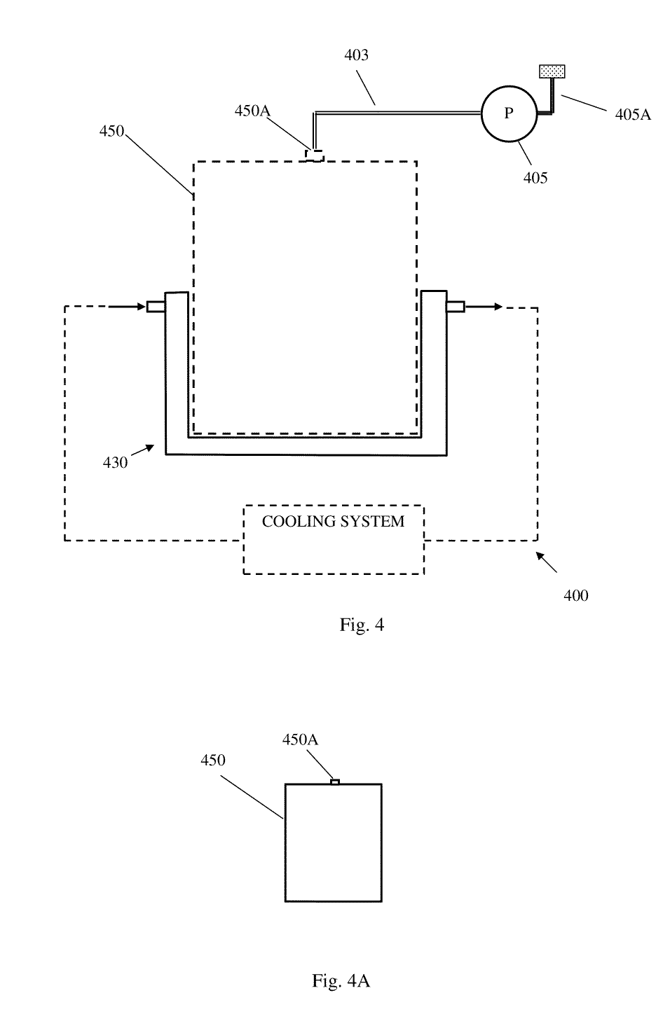

Reference is made now to FIGS. 4 and 4A which are schematic illustration of pressurizing and foaming device 400 and of a container 450 to be used with it, according to embodiments of the present invention. In some embodiments containers for the on-site production of foamed an pressurized products may comprise the ingredients for the production of the end product, either with the respective fluid (e.g. water, milk, etc.) or without fluids. The containers may be sealed until use, or openable for the insertion of fluids. The containers may be prepared for long storage under controlled storage conditions (e.g. certain storage temperature), or may be prepared for storage in common home conditions. The containers may be pre-prepared for pre-defined amount of pressurized an foamed product (e.g. personal amount, two persons-amount, etc.). Accordingly, container 450 may be adapted to fit into a cooling compartment 450 of device 400 and may be adapted further to receive pressurized gas from pressure production unit 405 via pressure hose 403 into container 450 via container pressure plug 450A. Device 400 may be cooled using an independent cooling device, or be fed from another cooling system, as depicted by the dashed line cooling production unit in FIG. 4. According to the embodiment depicted in FIGS. 4 and 4A at the end of the production of the pressurized and foamed product container 450 may be taken out of device 400 and the pressurized product may be provided via plug 450A, as is explained in details below.

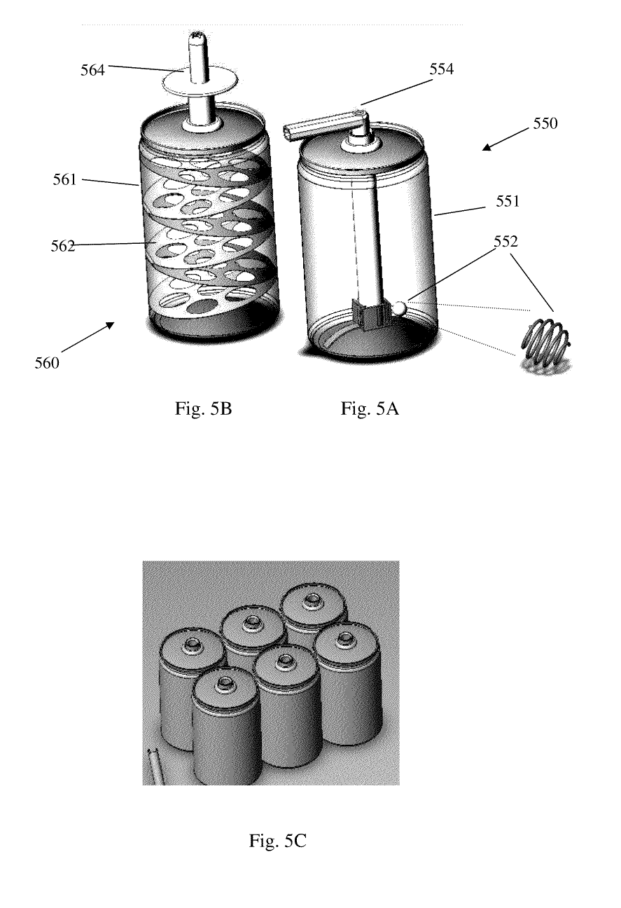

Reference is made now to FIGS. 5A, 5B and 5C, which are schemtatic illustration of of container 550 comprising magnetically driven strirer, of coantainer 560 with internal cooling conducting elements, and of 6-pack of containers, according to embodiments of the present invention. Container 550 may comprise container body 551, container product providing hose 554 and internal stirrer 552. Stirrer 552 may be formed as a helical ball-shaped spring, made of magnetically attractable material, that may be rotated inside container 550 by the activation of an external rotating magnetic field, as is known in the art. Stirrer 552 may assist in infusing gas/air into the product inside container 550 due o its rotation inside container 550.

Container 560 comprises internal foils of thin metal crossing the internal space in planes which are substantially perpendicular to an imaginary longitudinal axis of the container. These foils ma assist in transferring heat form the inside of container 560 to the outside of which, thus enabling faster chilling of the container's content.

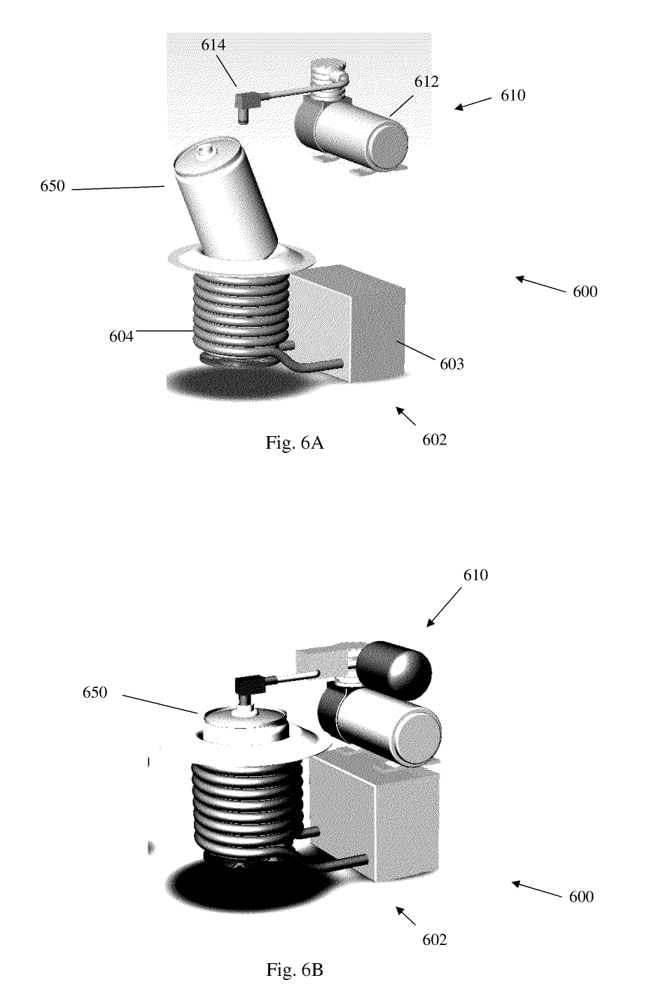

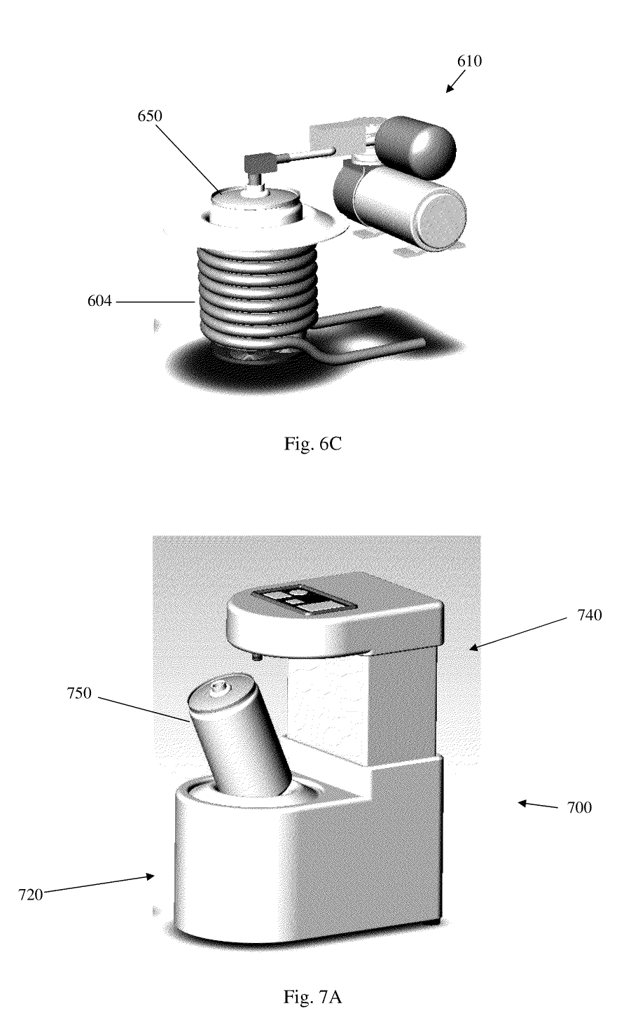

Reference is made now to FIGS. 6A, 6B and 6C which present schematically various embodiments of devices for the production of pressurized and foamed products, according to embodiments of the present invention. Device 660 comprise pressure production unit 610 and cooling unit 6602. Cooling unit may comprise cooling gas pressurizing unit 603 and cooling compartment 604, adapted to receive and host container 650 for the production of pressurized and foamed products. In FIG. 6A container 650 is shown partially out of cooling compartment 604. FIG. 6B presents device 600 in which container 650 is fully inserted into conmpartment 604 and is connected to pressure production unit via pipe and plug 614. FIG. 6C depicts device 680 comprising pressurep production unit 610 and cooling compartment 604, adapted to be connected to an external pressurized cooling gas unit (not shown), according to embodiments of the present invention.

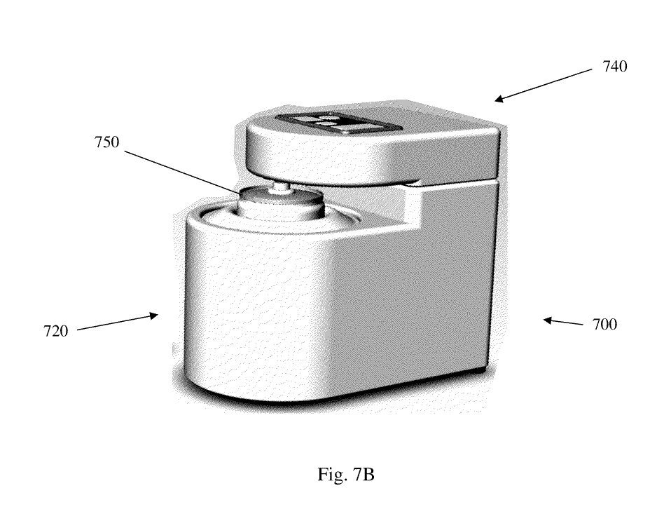

Reference is made now to FIGS. 7A and 7B, which depict device 700 for the production of pressurized and foamed products according to embodiments of the present invention. Device 700 may comprise two main parts 720 and 740. Main part 720 may comprise cooling unit and cooling compartment, and pressure production unit, while second main unit 740 may compruise pressure providing plug (such as plug 614 of FIG. 6A). Main part 740 may slidably be connected to main part 720, allowing main part 740 to slightly get apart from main part 720, thus allowing the insertion of container, such as container 750, into its respective cooling compartment in main part 720. When container 740 is properly located in the cooling compartment the sliding of main part 740 towards main part 720 will cause pressure providing part (such as plug 614) to connect to a respective plug such as plug 450A in container 750.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A device for foaming product comprising:
a main tank wherein said main tank is capable of being closed pressure-tight;
an ingredients capsule chamber; and
a pressure pump,
wherein said pressure pump is connected via an inlet pipe to said ingredients capsule chamber and via outlet pipe to said main tank and said main tank is connected via a third pipe to said ingredients capsule chamber, and
wherein when said pressure pump is operating it provides pressured air via said ingredients capsule chamber to said main tank and from said main tank to said ingredients capsule chamber.

2. The device of claim 1 further comprising a gas tank connected via a gas valve and gas inlet pipe to said third pipe to provide gas via said ingredients capsule chamber in addition to gas provided from said main tank.

3. The device of claim 2 wherein opening and closing of said gas valve is controllable in response to changes in the gas pressure in said main tank.

4. The device of claim 3 further comprising a cooling unit to cool the content of said main tank.

5. The device of claim 4 wherein said product is one from a list including egg-white, diary ice cream and soft serve ice cream.

6. The device of claim 5 wherein when said pressure pump is operating the volume of said product is extended (overrun) by at least 30%.

7. The device of claim 6 wherein said overrun is no less than 55%.

8. The device of claim 2 wherein said pressure pump is adapted to raise the pressure in said main tank to a value between 50 psi to 300 psi.

9. The device of claim 4 wherein said cooling unit is adapted to cool said product to a temeperature in the range of −35° C.-10° C.

10. A method for foaming products comprising:
providing pressurized gas via an ingredients capsule camber to a main tank, said main tank comprising said product;
providing pressurized gas from said main tank back to said ingredients capsule chamber; and
providing added gas from a gas tank via a gas valve to said ingredients capsule chamber,
wherein said gas valve is controllable in response to changes in the pressure in said main tank.

11. The method of claim 10 further comprising cooling said product in said main tank.

12. The method of claim 10 is repeated until the pressure in said main tank reaches a value in the range of 50 psi to 300 psi.

13. The method of claim 10 repeated until the volume of said product is extended by at least 30%.

14. The method of claim 13 wherein the volume of said product is extended at least by 55%.
